(19) United States
(12) Patent Application Publication
(10) Pub. No.: US 2013/0320121 A1
(43) Pub. Date: Dec. 5, 2013

(54) Automatic Disk Destroying Apparatus

(71) Applicant: Joseph Y KO, Irvine, CA (US)

(72) Inventor: Joseph Y KO, Irvine, CA (US)

(21) Appl. No.: 13/488,049

(22) Filed: Jun. 4, 2012

(51) Int. Cl. B02C 23/00

(52) U.S. Cl. 241/63

(57) ABSTRACT

An automatic disk destroying apparatus includes a conveying unit, a feeding unit and a destroying unit. The conveying unit includes a conveying track to hold at least one disk, a disk process portion connected to the conveying track and a thrust element pushing the at least one disk towards the disk process portion. The disk process portion includes a release passage to allow the at least one disk to escape the conveying unit. The feeding unit includes a drive member and a movable member driven by the drive member to move the at least one disk away from the conveying unit. The destroying unit is located corresponding to the release passage and includes a plurality of cutters and a cutting path between the plurality of cutters communicating with the release passage to receive the at least one disk.

### FIELD OF THE INVENTION

The present invention relates to a disk destroying apparatus and particularly to an apparatus capable of automatically destroying a great amount of disks in batches.

### BACKGROUND OF THE INVENTION

Optical disks are media to store signal data by converting them through an embossing technique into series of pits and planes of varying sizes. Advance of technology makes high capacity optical disks available on the market now, such as SACD, DVD or Blue light disks. They are convenient high quality audio and video media. However, a great deal of waste optical disks also are created. If these waste optical disks are not being destroyed through a proper process the confidential data stored inside could be distributed by ill-intentioned people. To prevent disclosure of classified data most optical disks have to be destroyed until not readable before being recycled.

Conventional optical disk signal destroyers, such as R.O.C. utility patent M256563 includes an operation body and at least one scraping cutter. The operation body is formed in a U shape including an upper body and a lower body. The scraping cutter is installed on the upper body or lower body. When in use the optical disks are loaded into the U-shaped body, and the upper and lower bodies are pressed to destroy the optical disk via the scraping cutter. While it can thoroughly destroy the optical disks, it is operated manually. When a great amount of optical disks have to be destroyed a great deal of labor is needed.

To remedy the aforesaid drawback an automatic optical disk signal destroyer has been developed and introduced, referring to R.O.C. utility patent M247993. It includes a holder and a scraper. The holder has a recess at the top to hold the optical disk. The scraper includes a motor, a tray installed on an output shaft of the motor and a scraping element located at the bottom side of the tray. The scraper straddles the optical disk with the scraping element in contact with the signal surface at the top side thereof. The scraping element covers the index entry zone of the optical disk. When the motor is activated and spins the tray and scraping element also spin to scrape the signals on the index entry zone.

Although the aforesaid destroyer can wreck the optical disk via the scraping element driven by the motor to achieve automatic destroying purpose, it does not have an automatic optical disk feeding mechanism and can destroy only one piece of optical disk at a time. Hence it also does not resolve the problem of consuming a great deal of labor when a great amount of optical disks have to be destroyed.

### SUMMARY OF THE INVENTION

The primary object of the present invention is to overcome the problem of the conventional techniques that do not have an optical disk feeding mechanism and cannot automatically destroy a great amount of optical disks.

To achieve the foregoing object the present invention provides an automatic disk destroying apparatus that includes a conveying unit, a feeding unit and a destroying unit. The conveying unit includes a conveying track to hold at least one disk, a disk process portion connected to the conveying track to position the at least one disk and a thrust element butting the at least one disk in the conveying track to move towards the disk process portion. The disk process portion includes a release passage to allow the at least one disk to escape the conveying unit. Each disk has an interim position in the at least one disk process portion where it is held and a release position to enter the release passage. The feeding unit includes a drive member and a movable member driven by the drive member and movable reciprocally in a thrust path to push the at least one disk from the interim position to the release position. The destroying unit is located corresponding to the release passage and includes a plurality of cutters and a cutting path formed between the plurality of cutters communicating with the release passage to receive the at least one disk leaving the conveying unit.

In an embodiment of the invention the feeding unit includes a switching assembly electrically connected to the drive member. The switching assembly includes a release switch corresponding to the at least one disk held on the interim position and a return switch corresponding to the at least one disk located on the release position. The movable member is in contact with the release switch to make the at least one disk moving from the interim position to the release position.

In another embodiment, the drive member is triggered by the release switch and spins forwards to move the at least one disk from the interim position to the release position. The drive member also can spin inversely against the forward spinning by triggering of the return switch.

In yet another embodiment the drive member includes a connection bar connected to the movable member.

In yet another embodiment the conveying unit includes a housing trough to hold the at least one disk, and the thrust element and the disk process portion are located at two ends of the housing trough, and the conveying track is located in the housing trough.

In yet another embodiment the thrust element includes an elastic element formed with an extensible zone and located on the conveying track and a butting plate connected to the elastic element to push the at least one disk.

In yet another embodiment the destroying unit includes an electric motor and a gear set driven by the electric motor. The gear set drives the plurality of cutters and moves the at least one disk along the cutting path.

In yet another embodiment the destroying unit includes a plurality of driven bars run through the plurality of cutters and a partition set to hold the driven bars. The plurality of cutters have apertures run through by the plurality of driven bars.

In yet another embodiment the automatic disk destroying apparatus further includes a middle housing below the housing trough to hold the destroying unit. The middle housing has a discharge outlet corresponding to the cutting path.

In yet another embodiment the automatic disk destroying apparatus further includes a collection housing below the middle housing to collect the at least one disk passing through the discharge outlet.

By means of the structure set forth above, compared with the conventional techniques, the invention provides many advantages, notably:

It can destroy a great amount of optical disks in batches. The apparatus of the invention includes a conveying unit to convey at least one disk, a feeding unit to move the at least one disk away from the conveying unit and a destroying unit to cut the at least one disk leaving the conveying unit. The feeding unit is driven by a motor. The conveying unit continuously supplies the optical disks to be processed through an elastic element. Hence the conveying unit and feeding unit form an automatic feeding mechanism. The destroying unit also is driven by the motor, and can continuously destroy the optical disks supplied by the automatic feeding mechanism. Thus a great amount of optical disks can be destroyed in batches by the apparatus of the invention.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a fragmentary exploded view of an embodiment of the invention.

FIG. 2 is a sectional view of an embodiment of the invention.

FIG. 3 is a schematic view of an embodiment of the invention in an operating condition.

FIG. 4 is a schematic view of an embodiment of the invention in another operating condition.

### DETAILED DESCRIPTION OF THE PREFERRED EMBODIMENT

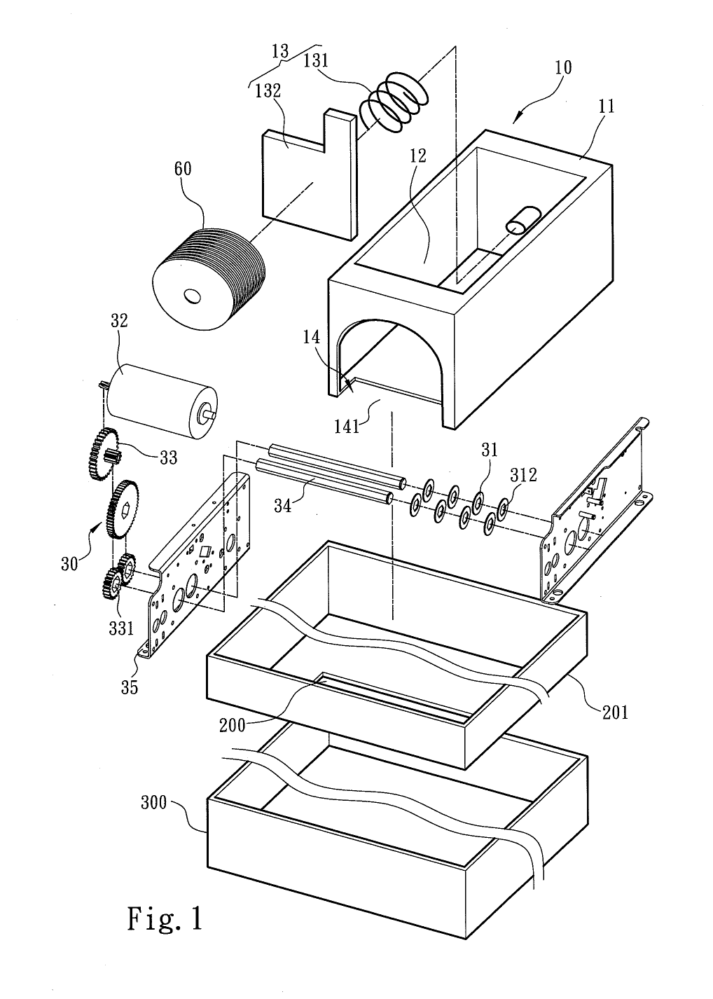

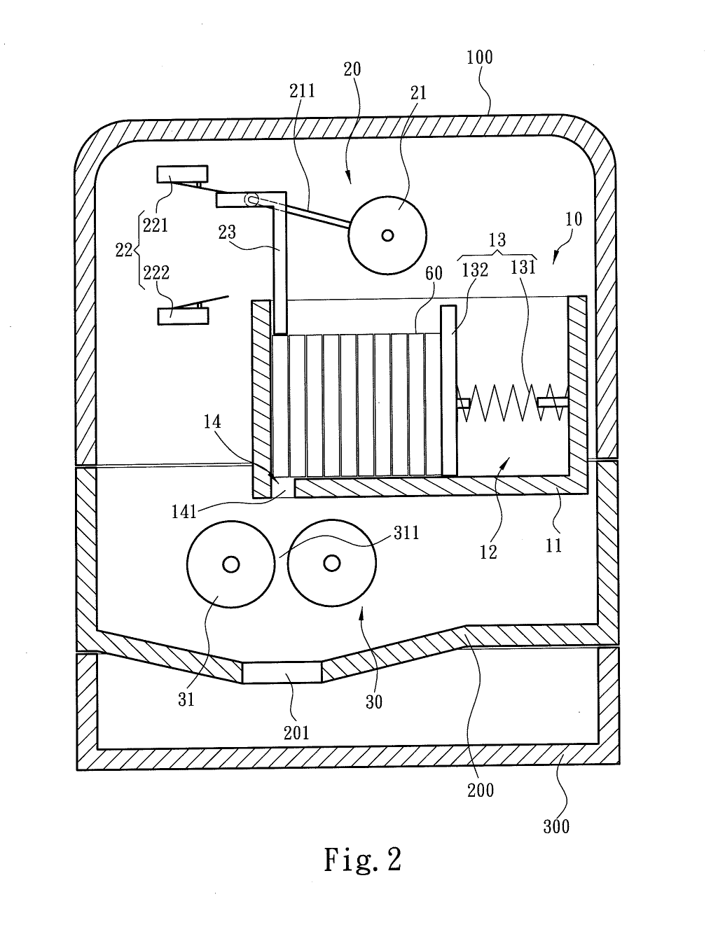

Please refer to FIGS. 1 and 2 for an embodiment of the invention. The automatic disk destroying apparatus of the invention is located between an upper housing 100 and a lower housing 200 that are coupled together. It mainly includes a conveying unit 10 to convey at least one disk 60, a feeding unit 20 to deliver sequentially the disks 60 and a destroying unit 30 to destroy the disks 60.

The conveying unit 10 is located in the upper housing 100 and includes a housing trough 11 to hold the disks 60, a conveying track 12 located in the housing trough 11 and a thrust element 13 and a disk process portion 14 at two ends of the housing trough 11. The disk process portion 14 is connected to the conveying track 12 to position the disks 60, and includes a release passage 141 to allow the disks 60 to escape the conveying unit 10. In this embodiment the release passage 141 allows only one disk 60 to pass through, but this is not the limitation of the invention. The thrust element 13 mainly aims to push the disks 60 on the conveying track 12 to move towards the disk process portion 14 to facilitate downstream process of the feeding unit 20. In order to make the disks 60 to be neatly stacked in the housing trough 11, the thrust element 13 includes an elastic element 131 equipped with an extensible zone and held in the conveying track 12 and a butting plate 132 connected to the elastic element 131. The butting plate 132 pushes the disks 60 through an elastic force of the elastic element 131.

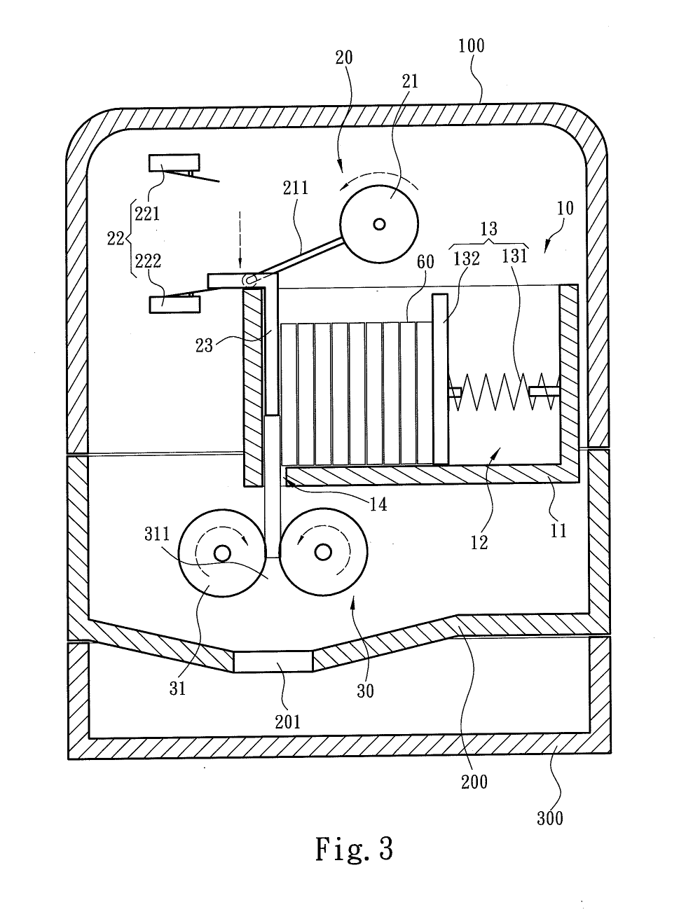

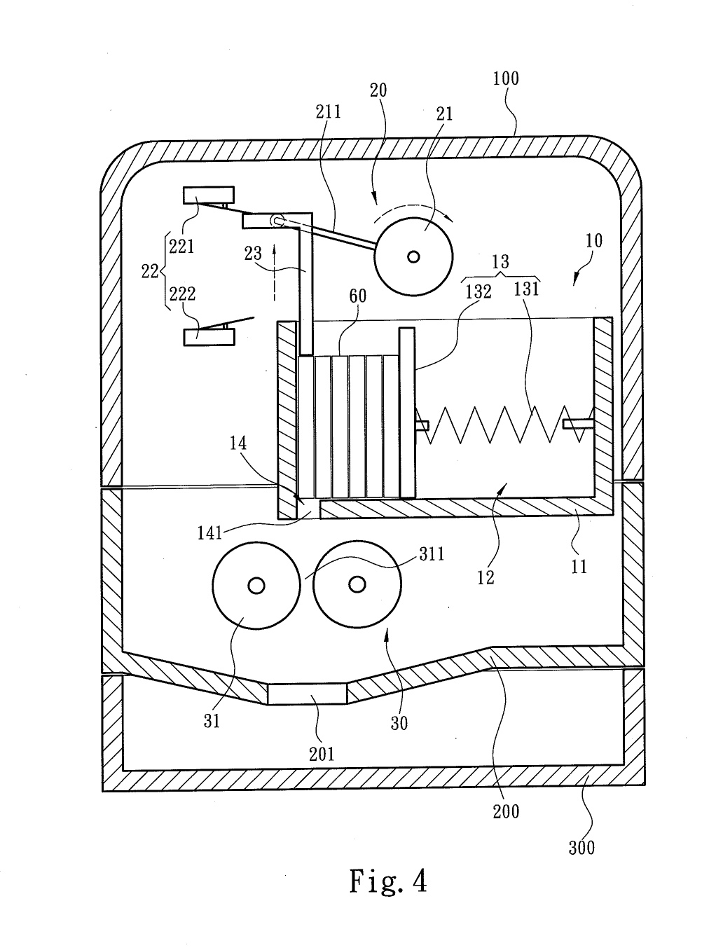

The feeding unit 20 is located in the upper housing 100 and includes a drive member 21, a switching assembly 22 electrically connected to the drive member 21 and a movable member 23 driven by the drive member 21 to move reciprocally on a thrust path. Referring to FIGS. 3 and 4, the disks 60 include an interim position held in the disk process portion 14 and a release position to enter the release passage 141. The thrust path allows the disks 60 to move from the interim position to the release position. The switching assembly 22 has a release switch 221 corresponding to the disk 60 at the interim position and a return position 222 corresponding to the disk 60 at the release position. The drive member 21 includes a connection bar 211 connecting to the movable member 23. In this embodiment the drive member 21 is an electric motor equipped with the connection bar 211 and can spin in a forward direction or inverse, but this is not the limitation of the invention.

The destroying unit 30 is located corresponding to the release passage 141 and includes a plurality of cutters 31 and a cutting path 311 between the cutters 31 communicating with the release passage 141 to receive the disk 60 leaving the conveying unit 10. In addition, the destroying unit 30 includes an electric motor 32, a gear set 33 driven by the electric motor 32, a plurality of driven bars 34 run through the cutters 31 and gear set 33, and a partition set 35 to hold the driven bars 34. The driven bars 34 are driven by the gear set 33 to drive the cutters 31 spinning and make the disk 60 to be engaged with the cutters 31 and moved downwards along the cutting path 311. The cutters 31 and gear set 33 have respectively apertures 312 and 331 run through by the driven bars 34.

The middle housing 200 holds the destroying unit 30 and has a discharge outlet 201 corresponding to the cutting path 311. To facilitate collecting of the disk 60 passing through the discharge outlet 201 for centralized processing a collection housing 300 is provided beneath the middle housing 200 to do disk collection.

Please refer to FIGS. 3 and 4 for an embodiment of the invention in operating conditions. As shown in FIGS. 2 and 3, first, a user loads the disks 60 onto the conveying track 12 from above the housing trough 11; at the beginning, one disk 60 is placed on the interim position of the disk process portion 14, and the movable member 23 triggers the release switch 221 which in turn triggers the drive member 21 to spin forwards; next, the drive member 21 moves the disk 60 via the movable member 23 from the interim position to the release position; the disk 60 at the disk process portion 14 is pushed downwards via the movable member 23 to leave the disk process portion 14 from the release passage 141 and enter the cutting passage 311; the cutters 31 are driven by the electric motor 32 to spin continuously, and the disk 60 is moved through the cutting path 311 to be destroyed efficiently.

Referring to FIG. 3, after the movable member 23 has carried the disk 60 to the release position, the movable member 23 triggers the return switch 222 which in turn triggers the drive member 21 to spin inversely. The drive member 21 carries the movable member 23 to the start position as shown in FIG. 4, meanwhile, no disk 60 remains on the disk process portion 14, hence the thrust element 13 moves another disk 60 via the elastic force of the elastic element 131 to the disk process portion 14; thus the aforesaid process can be repeatedly performed to destroy all the disks 60 sequentially without manual operation. Therefore the apparatus of the invention can perform automatic disk destroying operation as desired.

As a conclusion, the automatic disk destroying apparatus of the invention includes a conveying unit to convey at least one disk, a feeding unit to move the disk away from the conveying unit and a destroying unit to cut the disk leaving the conveying unit. Such a structure provides an automatic disk destroying process and can wreck a greater amount of waste disks to meet requirements of users who have such a need. It provides significant improvements over the conventional techniques.

While the preferred embodiment of the invention has been set forth for the purpose of disclosure, it is not the limitation of the invention, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. An automatic disk destroying apparatus, comprising:
a conveying unit including a conveying track to hold at least one disk, a disk process portion connecting to the conveying track to position the at least one disk and a thrust element to push the at least one disk on the conveying track towards the disk process portion, the disk process portion including a release passage to allow the disk to escape the conveying unit, the at least one disk including an interim position retaining on the disk process portion and a release position entering the release passage;
a feeding unit including a drive member and a movable member driven by the drive member and movable reciprocally on a thrust path to move the at least one disk from the interim position towards the release position; and
a destroying unit corresponding to the release passage and including a plurality of cutters and a cutting path formed between the cutters communicating with the release passage to receive the at least one disk leaving the conveying unit.

2. The automatic disk destroying apparatus of claim 1, wherein the feeding unit includes a switching assembly electrically connected to the drive member, the switching assembly including a release switch corresponding to the at least one disk at the interim position and a return switch corresponding to the at least one disk at the release position, the movable member triggering the release switch to move the at least one disk from the interim position to the release position.

3. The automatic disk destroying apparatus of claim 2, wherein the drive member is triggered by the release switch to spin forward to move the at least one disk from the interim position to the release position and the drive member also is triggered by the return switch to spin inversely against the forward spinning.

4. The automatic disk destroying apparatus of claim 1, wherein the drive member includes a connection bar connecting to the movable member.

5. The automatic disk destroying apparatus of claim 1, wherein the conveying unit includes a housing trough to hold the at least one disk, the thrust element and the disk process portion being located at two ends of the housing trough, the conveying track being located in the housing trough.

6. The automatic disk destroying apparatus of claim 1, wherein the thrust element includes an elastic element equipped with an extensible zone in the conveying track and a butting plate connecting to the elastic element to push the at least one disk.

7. The automatic disk destroying apparatus of claim 1, wherein the destroying unit includes an electric motor and a gear set driven by the electric motor, the gear set driving the plurality of cutters to move the at least one disk along the cutting path.

8. The automatic disk destroying apparatus of claim 7, wherein the destroying unit includes a plurality of driven bars running through the plurality of cutters and a partition set to hold the plurality of driven bars, the plurality of cutters including apertures run through by the plurality of driven bars.

9. The automatic disk destroying apparatus of claim 7 further including a middle housing below the housing trough to hold the destroying unit, the middle housing including a discharge outlet corresponding to the cutting path.

10. The automatic disk destroying apparatus of claim 9 further including a collection housing below the middle housing to collect the at least one disk passing through the discharge outlet.
